(19) United States
(12) Patent Application Publication
(10) Pub. No.: US 2025/0262785 A1
(43) Pub. Date: Aug. 21, 2025

(54) Terminal Strip Cutting System and Terminal Strip Cutting Method

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Lei (Alex) Zhou, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/057,270

(22) Filed: Feb. 19, 2025

(30) Foreign Application Priority Data
Feb. 19, 2024 (CN) 202410185847.5

(51) Int. Cl. B26D 5/24; H01R 43/16

(52) U.S. Cl. CPC B26D 5/24; H01R 43/16

(57) ABSTRACT

A terminal strip cutting system includes a conveying device, a braking device, a position detection device, a position judgment device, and a cutting device. The conveying device conveys a terminal strip in a predetermined direction. The braking device is adapted to brake the terminal strip to stop it. The position detection device is adapted to detect a stop position of the terminal strip. The position judgment device is adapted to determine whether the terminal strip has stopped at a correct cutting position based on the detection result of the position detection device. The cutting device is adapted to cut off the carrier tape of the terminal strip in order to cut a section of terminal strip from the conveyed terminal strip. When the position judgment device determines that the terminal strip is stopped at the correct cutting position, the cutting device is closed and cuts off the carrier tape.

### CROSS-REFERENCE TO RELATED APPLICATION

This application claims the benefit of Chinese Patent Application No. CN202410185847.5 filed on Feb. 19, 2024 in the State Intellectual Property Office of China, the whole disclosure of which is incorporated herein by reference.

### FIELD OF THE DISCLOSURE

The present disclosure relates to a terminal strip cutting system and a method for cutting a terminal strip by using the terminal strip cutting system.

### BACKGROUND OF THE INVENTION

In the prior art, when processing terminal strips, it is relatively easy to unintentionally cut terminals on the terminal strip due to the lack of a terminal strip stop position detection device. This not only causes damage to the terminals, but also requires re-cutting the terminal strip, seriously affecting the cutting accuracy and efficiency of the terminal strip processing.

### SUMMARY OF THE INVENTION

According to an embodiment of the present disclosure, a terminal strip cutting system includes a conveying device, a braking device, a position detection device, a position judgment device, and a cutting device. The conveying device is adapted to convey a terminal strip in a predetermined direction. The braking device is adapted to brake the terminal strip to stop it. The position detection device is adapted to detect a stop position of the terminal strip. The position judgment device is adapted to determine whether the terminal strip has stopped at a correct cutting position based on the detection result of the position detection device. The cutting device is adapted to cut off the carrier tape of the terminal strip in order to cut a section of terminal strip from the conveyed terminal strip. When the position judgment device determines that the terminal strip is stopped at the correct cutting position, the cutting device is closed and cuts off the carrier tape of the terminal strip.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal strip cutting system according to an exemplary embodiment of the present invention when viewed from the rear side;

FIG. 2 shows an illustrative plan view of a terminal strip cutting system according to an exemplary embodiment of the present invention;

FIG. 3 shows an illustrative perspective view of a terminal strip cutting system according to an exemplary embodiment of the present invention when viewed from the front side;

FIG. 4 shows an illustrative perspective view of the conveying device of the terminal strip cutting system according to an exemplary embodiment of the present invention;

FIG. 5 shows an illustrative perspective view of the braking device and counting device of the terminal strip cutting system according to an exemplary embodiment of the present invention;

FIG. 6 shows an illustrative perspective view of the braking device of the terminal strip cutting system according to an exemplary embodiment of the present invention;

FIG. 7 shows an illustrative plan view of the position detection device of the terminal strip cutting system according to an exemplary embodiment of the present invention, wherein the terminal strip is not stopped at the correct cutting position; and

FIG. 8 shows an illustrative plan view of the position detection device of the terminal strip cutting system according to an exemplary embodiment of the present invention, wherein the terminal strip is stopped at the correct cutting position.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal strip cutting system comprises: a conveying device for conveying a terminal strip in a predetermined direction; a braking device which is used to brake the terminal strip to stop it; a position detection device for detecting the stop position of the terminal strip; a position judgment device which is used to determine whether the terminal strip has stopped at a correct cutting position based on the detection result of the position detection device; and a cutting device which is used to cut off the carrier tape of the terminal strip, in order to cut a section of terminal strip from the conveyed terminal strip. When the position judgment device determines that the terminal strip is stopped at the correct cutting position, the cutting device is closed and cuts off the carrier tape of the terminal strip.

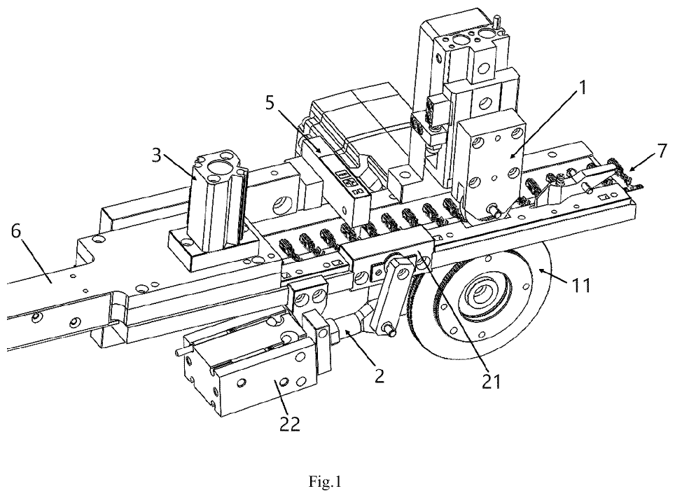

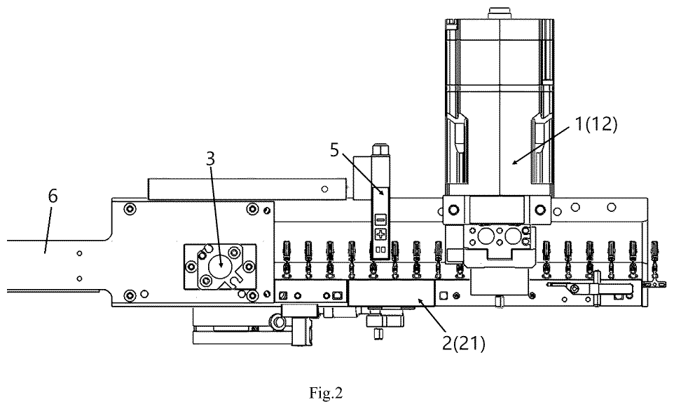

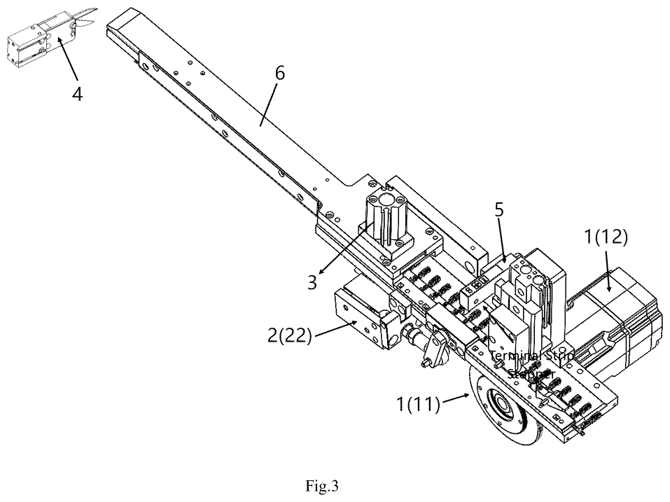

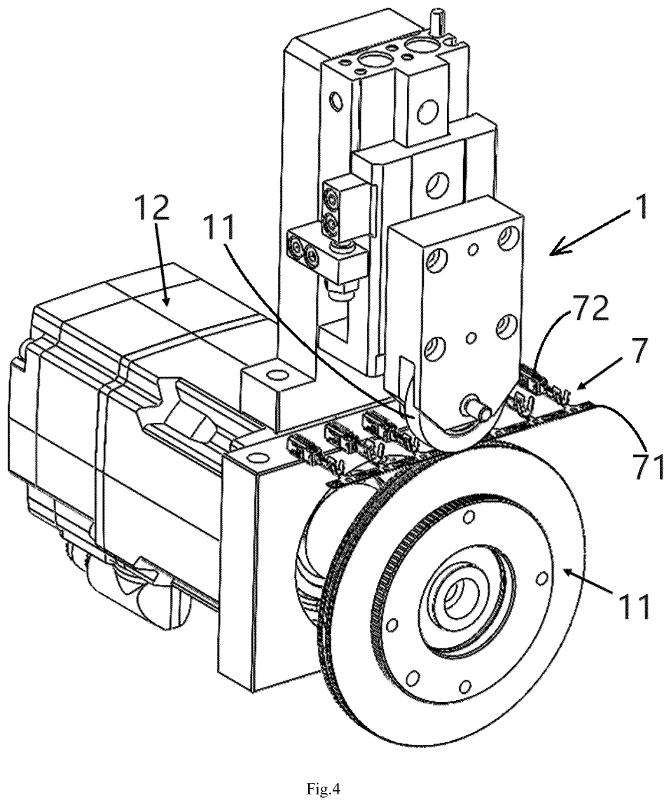

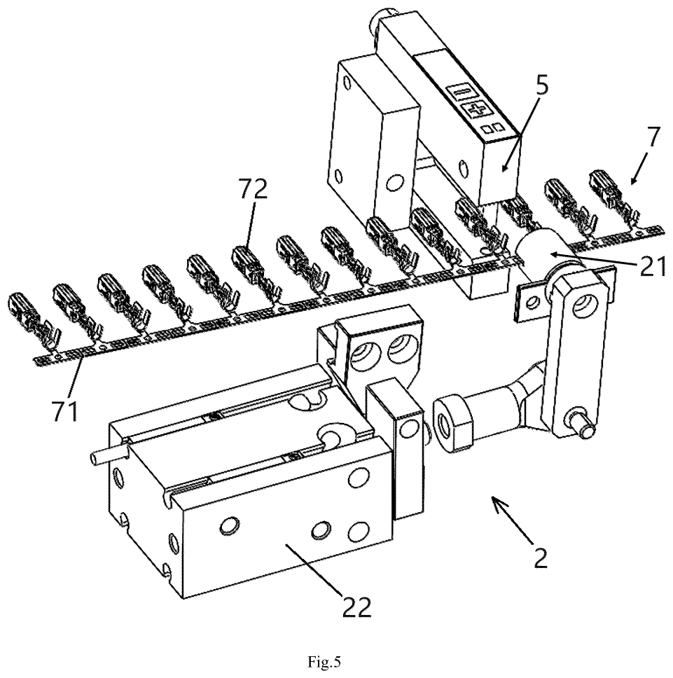

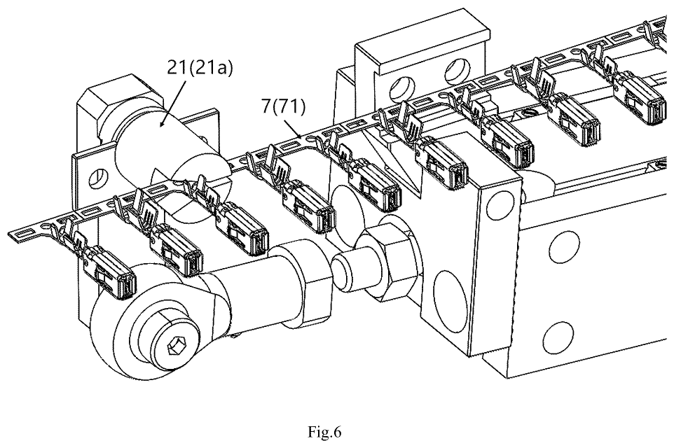

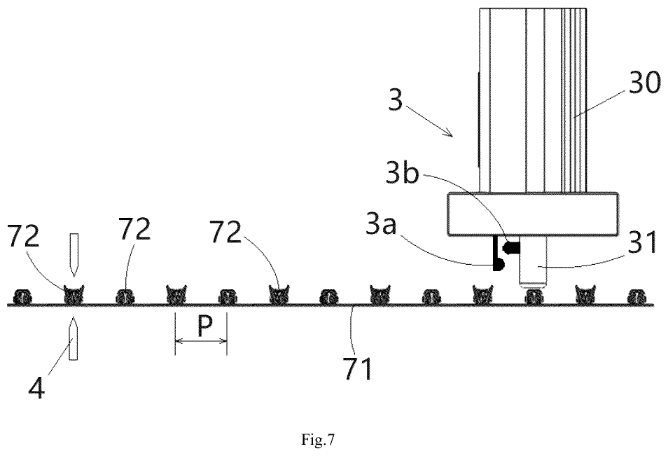

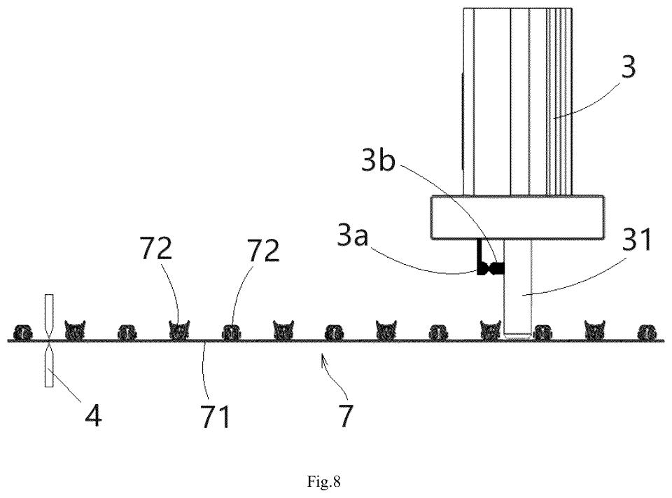

FIG. 1 shows an illustrative perspective view of a terminal strip cutting system according to an exemplary embodiment of the present invention when viewed from the rear side. FIG. 2 shows an illustrative plan view of a terminal strip cutting system according to an exemplary embodiment of the present invention. FIG. 3 shows an illustrative perspective view of a terminal strip cutting system according to an exemplary embodiment of the present invention when viewed from the front side. FIG. 4 shows an illustrative perspective view of the conveying device of the terminal strip cutting system according to an exemplary embodiment of the present invention. FIG. 5 shows an illustrative perspective view of the braking device and counting device of the terminal strip cutting system according to an exemplary embodiment of the present invention. FIG. 6 shows an illustrative perspective view of the braking device of the terminal strip cutting system according to an exemplary embodiment of the present invention. FIG. 7 shows an illustrative plan view of the position detection device of the terminal strip cutting system according to an exemplary embodiment of the present invention, wherein the terminal strip is not stopped at the correct cutting position. FIG. 8 shows an illustrative plan view of the position detection device of the terminal strip cutting system according to an exemplary embodiment of the present invention, wherein the terminal strip is stopped at the correct cutting position.

As shown in FIGS. 1-8, in an exemplary embodiment of the present disclosure, a terminal strip cutting system is disclosed. The terminal strip cutting system includes: a conveying device 1, a braking device 2, a position detection device 3, a position judgment device which may be incorporated into a counting device 5 (and thus, represented by the counting device 5 in the figures), and a cutting device 4. The conveying device 1 is used to transport a terminal strip 7 in a predetermined direction. The braking device 2 is used to brake the terminal strip 7 to stop it. The position detection device 3 is used to detect the stop position of the terminal strip 7. The position judgment device is used to determine whether the terminal strip 7 is stopped at the correct cutting position based on the detection result of the position detection device 3. The position judgment device (e.g., incorporated into the counting device 5) can be a detection circuit, or a functional device running in a computer, which may be separate from, or arranged internally within, the illustrated system housing. The cutting device 4 is used to cut the carrier tape 71 of the terminal strip 7, in order to cut a section of the terminal strip 7 from the conveyed terminal strip 7. When the position judgment device determines that the terminal strip 7 is stopped at the correct cutting position, the cutting device 4 closes and cuts off the carrier tape 71 of the terminal strip 7.

The position detection device 3 includes a retractable probe 31. The probe 31 extends towards the terminal strip 7 after the terminal strip 7 is stopped to detect the stop position of the terminal strip 7. When the probe 31 is pressed against the top of a terminal 72 on the terminal strip 7, the position judgment device determines that the terminal strip 7 is not stopped at the correct cutting position. When the probe 31 is inserted into a gap between adjacent terminals 72 on the terminal strip 7, the position judgment device determines that the terminal strip 7 is stopped at the correct cutting position.

In the illustrated embodiment, the probe 31 and the cutting device 4 are separated by a predetermined distance in the conveying direction of the terminal strip 7, and the predetermined distance is equal to, slightly greater than, or slightly less than an integer multiple of the pitch P between adjacent two terminals 72 on the terminal strip 7. The probe 31 can float elastically to prevent the pushing force applied by the probe 31 on the terminal strip 7 from exceeding the predetermined value, so that the terminal strip 7 will not be damaged by the probe 31.

In the illustrated embodiment, the position detection device 3 includes a cylinder 30, and the probe 31 is the telescopic rod of the cylinder 30. The position detection device 3 further comprises a detection switch 3a, 3b, which includes a static contact 3a that does not move with the probe 31 and a movable contact 3b that moves with the probe 31. When the probe 31 is pressed against the top of a terminal 72 on the terminal strip 7, the movable contact 3b and the static contact 3a are in an electrically separated position; When the probe 31 is inserted into the gap between adjacent terminals 72 on the terminal strip 7, the movable contact 3b and the static contact 3a are in electrical contact position.

The position judgment device determines whether the terminal strip 7 is stopped at the correct cutting position based on the on/off status of the detection switch 3a, 3b. When the detection switch 3a, 3b is in the on state, the position judgment device determines that the terminal strip 7 is stopped at the correct cutting position. When the detection switch 3a, 3b is in the off state, the position judgment device determines that the terminal strip 7 is not stopped at the correct cutting position.

The conveying device 1 includes a pair of rollers 11 and a servo motor 12. The carrier tape 71 of the terminal strip 7 is clamped between the pair of rollers 11. The servo motor 12 is connected to the rollers 11 and used to drive the rollers 11 to rotate. When the servo motor 12 drives the rollers 11 to rotate, the rollers 11 drive the terminal strip 7 forward with friction force.

The braking device 2 includes a brake 21 and a driving device 22. The brake 21 can be opened or closed. The driving device 22 is connected to the brake 21 and is used to drive the brake 21 to open or close. When the driving device 22 drives the brake 21 to close, the brake 21 clamps the carrier tape 71 of the terminal strip 7, causing the terminal strip 7 stopped. The brake 21 includes a pair of brake blocks 21, which can be opened and closed. The driving device 22 is used to drive the pair of brake blocks 21 to open or close.

The terminal strip cutting system further includes the counting device 5, which is used to count the terminals 72 on the conveyed terminal strip 7. When the counting device 5 counts to the predetermined number of terminals 72 being conveyed through the counting device 5, the conveying device 1 stops conveying the terminal strip 7, and the braking device 2 brakes the terminal strip 7 to ensure that the number of terminals 72 on a section of the terminal strip 7 cut from the conveyed terminal strip 7 is equal to the predetermined number. The terminal strip cutting system further includes a conveying channel 6, which is used to carry the terminal strip 7 and guide the terminal strip 7 to be conveyed in a predetermined direction.

When the position judgment device determines that the terminal strip 7 is not stopped at the correct cutting position, the braking device 2 releases the stopped terminal strip 7, the probe 31 of the position detection device 3 is retracted, and the conveying device 1 drives the terminal strip 7 to move forward a predetermined adjustment distance to adjust the stop position of the terminal strip 7 to the correct cutting position.

The predetermined adjustment distance is not greater than half of the pitch P between adjacent terminals 72 on the terminal strip 7. For example, the aforementioned predetermined adjustment distance can be equal to half, one-third, or quarter of the pitch P between adjacent terminals 72 on the terminal strip 7.

The braking device 2 brakes the terminal strip 7 at the same time as the conveying device 1 stops conveying the terminal strip 7, in order to brake the terminal strip 7 in a timely manner; the conveying device 1 can only drive the movement of terminal strip 7 after the braking device 2 has released it and the probe 31 of the position detection device 3 has been retracted.

As shown in FIGS. 1-8, in another exemplary embodiment of the present disclosure, a terminal strip cutting method is also disclosed. The terminal strip cutting method includes the following steps of:
S10: Provide the aforementioned terminal strip cutting system;
S20: Use the conveying device 1 to transport a terminal strip 7 forward in a predetermined direction;
S30: When the counting device 5 counts the predetermined number of terminals 72 being conveyed through, the conveying device 1 stops conveying the terminal strip 7 and uses the braking device 2 to brake the terminal strip 7;
S40: Use the position detection device 3 to detect the stop position of the terminal strip 7, and use the position judgment device to determine whether the stop position of terminal strip 7 is at the correct cutting position;
S50: When the position judgment device determines that the terminal strip 7 is stopped at the correct cutting position, perform the following step S80; When the position judgment device determines that the terminal strip 7 is not stopped at the correct cutting position, perform the following step S60;
S60: The braking device 2 releases the terminal strip 7, and uses the conveying device 1 to drive the terminal strip 7 to move forward a predetermined adjustment distance;
S70: Return to step S40; and
S80: Use the cutting device 4 to cut the carrier tape 71 of terminal strip 7, in order to cut a section of terminal strip 7 from the conveyed terminal strip 7.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal strip cutting system comprising:
a conveying device adapted to convey a terminal strip in a predetermined direction;
a braking device adapted to brake the terminal strip to stop it;
a position detection device adapted to detect a stop position of the terminal strip;
a position judgment device adapted to determine whether the terminal strip has stopped at a correct cutting position based on the detection result of the position detection device; and
a cutting device adapted to cut off the carrier tape of the terminal strip in order to cut a section of terminal strip from the conveyed terminal strip, when the position judgment device determines that the terminal strip is stopped at the correct cutting position, the cutting device is closed and cuts off the carrier tape of the terminal strip.

2. The terminal strip cutting system according to claim 1, wherein:
the position detection device includes a retractable probe extending towards the terminal strip after the terminal strip is stopped and adapted to detect the stop position of the terminal strip;
when the probe is pressed against the top of a terminal on the terminal strip, the position judgment device determines that the terminal strip is not stopped at the correct cutting position; and
when the probe is inserted into a gap between adjacent terminals on the terminal strip, the position judgment device determines that the terminal strip is stopped at the correct cutting position.

3. The terminal strip cutting system according to claim 2, wherein the probe and the cutting device are separated by a predetermined distance in the conveying direction of the terminal strip, and the predetermined distance is equal to or approximately equal to an integer multiple of the pitch between adjacent terminals on the terminal strip.

4. The terminal strip cutting system according to claim 2, wherein the probe can float elastically to prevent the pushing force applied by the probe on the terminal strip from exceeding a predetermined value, so that the terminal strip will not be damaged by the probe.

5. The terminal strip cutting system according to claim 2, wherein the position detection device comprises a cylinder, and the probe is the telescopic rod of the cylinder.

6. The terminal strip cutting system according to claim 2, wherein:
the position detection device further includes a detection switch, wherein the detection switch comprises a static contact that does not move with the probe and a movable contact that moves with the probe; and
when the probe is pressed against the top of a terminal on the terminal strip, the movable contact and the static contact are in an electrically separated position; and
when the probe is inserted into the gap between adjacent terminals on the terminal strip, the movable contact and the static contact are in electrical contact.

7. The terminal strip cutting system according to claim 6, wherein the position judgment device determines whether the terminal strip is stopped at the correct cutting position based on the on/off status of the detection switch.

8. The terminal strip cutting system according to claim 7, wherein:
when the detection switch is in the on state, the position judgment device determines that the terminal strip is stopped at the correct cutting position; and
when the detection switch is in the off state, the position judgment device determines that the terminal strip is not stopped at the correct cutting position.

9. The terminal strip cutting system according to claim 1, wherein the conveying device comprises:
a pair of rollers, with the carrier tape of the terminal strip clamped between the pair of rollers; and
a servo motor connected to the rollers for driving the rollers to rotate.

10. The terminal strip cutting system according to claim 9, wherein when the servo motor drives the rollers to rotate, the rollers drive the terminal strip forward with frictional force.

11. The terminal strip cutting system according to claim 1, wherein the braking device comprises:
a brake capable of being opened or closed; and
a driving device connected to the brake for driving the brake to open or close, when the driving device drives the brake to close, the brake clamps the carrier tape of the terminal strip to stop the terminal strip.

12. The terminal strip cutting system according to claim 11, wherein the brake comprises a pair of brake blocks that can be opened and closed, and the driving device is used to drive the pair of brake blocks to open or close.

13. The terminal strip cutting system according to claim 1, further comprising a counting device which is used to count the terminals on the conveyed terminal strip, when the counting device counts a predetermined number of terminals being conveyed through the counting device, the conveying device stops conveying the terminal strip, and the braking device brakes the terminal strip to ensure that the number of terminals on a section of the terminal strip cut from the conveyed terminal strip is equal to the predetermined number.

14. The terminal strip cutting system according to claim 1, further comprising a conveying channel adapted to carry the terminal strip and guide the terminal strip to be conveyed in a predetermined direction.

15. The terminal strip cutting system according to claim 1, wherein when the position judgment device determines that the terminal strip is not stopped at the correct cutting position, the braking device releases the terminal strip, the probe of the position detection device is retracted, and the conveying device drives the terminal strip to move forward a predetermined adjustment distance to adjust the stop position of the terminal strip to the correct cutting position.

16. The terminal strip cutting system according to claim 15, wherein the predetermined adjustment distance is not greater than half of the pitch between adjacent terminals on the terminal strip.

17. The terminal strip cutting system according to claim 15, wherein the predetermined adjustment distance is equal to half, one-third, or quarter of the pitch between adjacent terminals on the terminal strip.

18. The terminal strip cutting system according to claim 15, wherein the braking device brakes the terminal strip while the conveying device stops conveying the terminal strip, in order to brake the terminal strip in a timely manner; and

19. The terminal strip cutting system according to claim 18, wherein the conveying device can only drive the terminal strip to move after the braking device has released the terminal strip and the probe of the position detection device has been retracted.

20. A terminal strip cutting method comprising the steps of:
S10: providing the terminal strip cutting system as claimed in claim 1;
S20: using the conveying device to transport the terminal strip forward in a predetermined direction;
S30: when the counting device counts a predetermined number of terminals being conveyed through, the conveying device stops conveying the terminal strip and the braking device brakes the terminal strip;
S40: using the position detection device to detect the stop position of the terminal strip, and use a position judgment device to determine whether the stop position of the terminal strip is at the correct cutting position;
S50: if the position judgment device determines that the terminal strip is stopped at the correct cutting position, performing the following step S80; if the position judgment device determines that the terminal strip is not stopped at the correct cutting position, performing the following step S60;
S60: the braking device releases the terminal strip, and using the conveying device to drive the terminal strip to move forward a predetermined adjustment distance;
S70: returning to the step S40; and
S80: using the cutting device to cut off the carrier tape of the terminal strip, in order to cut a section of the terminal strip from the conveyed terminal strip.
